(19) United States
(12) Patent Application Publication
(10) Pub. No.: US 2007/0269556 A1
(43) Pub. Date: Nov. 22, 2007

(54) Manufacture Method of Sauce, a Sauce Product, and a Container for the Sauce Product

(76) Inventor: Pekka Virtanen, Vantaa (FI)

Correspondence Address: SALTAMAR INNOVATIONS, 30 FERN LANE, SOUTH PORTLAND, ME, 04106, US

(21) Appl. No.: 11/576,336

(22) PCT Filed: Sep. 29, 2005
(86) PCT No.: PCT/FI05/50338

§ 371 Date: Jul. 6, 2007

(30) Foreign Application Priority Data
Sep. 30, 2004 (FI) 20045365

(51) Int. Cl. A23L 1/39; A23B 4/06; A47J 36/14; A47J 36/24; A23B 4/10

(52) U.S. Cl. 426/68; 426/113; 426/114; 99/340

(57) ABSTRACT

In the method thickening and precipitable substances are mixed with the other sauce components resulting in a mixture reaching a predetermined viscosity by means of the precipitable substance. Then the mixture is frozen to at least −10° C. and placed in a container which withstands deep-freezing and heating. The container must provide predetermined size of space at the bottom of the container for defrosting and thickening the mixture. In addition to the method, the invention comprises a sauce product utilizing the same principles, and a container for the sauce product.

### FIELD OF THE INVENTION

The present invention relates to the preparing and freezing of foodstuffs, in more detail, to the manufacturing of sauce.

### BACKGROUND OF THE INVENTION

Products of industrial food manufacturing are familiar to people who deal with groceries. Ready-made foods are foodstuffs which are ready to be enjoyed immediately after warming. In addition to ready-made foods, there are different types of prepared foodstuffs and food components on markets. An example would be powder which is packed in portion bags and from which sauce can be made by adding water to the powder and boiling the resulting mixture.

Freezing is a known method in order to conserve foodstuffs so that it is edible a long time. For example, fish is conserved by freezing. Publication DE2134175 describes a method for covering fish with an ice layer. Fish includes fat that becomes oxidized thus worsening the flavor of the fish. Because the fat also becomes oxidized at a low temperature, a water layer is frozen onto the surface of the fish. The ice formed in this way inhibits oxidation of the fish oil. In addition, DE2134175 describes how spices can be added to water before the water is frozen onto the surface of the fish so that when the fish is cooked for a meal, the ice melts and the spices added to the water flavor the fish.

Publication GB1448495 describes a method for adding prepared sauce to the product to be frozen. In the method a ready hydrocolloid sauce, such as a starch-based sauce which includes fat, is applied over a product.

Patent FI100938 (WO9637111), granted formerly to the applicant, concerns a method for preparing a portion/food piece. At first the portion is frozen to at least −15° C. (degrees Celsius), a sauce layer is frozen onto the surface of the portion, and lastly the layer inhibiting the fat oxidation is frozen onto the sauce layer. The layers can be applied onto the surface of the portion by spraying, by atomizing, or by dipping the portion into the sauce or some other liquid. The portion may be a whole piece of meat, fish, broiler meat, or another foodstuffs. If required, the foodstuffs are already cut into cubes or strips, or minced, in which case they may be uncooked, whereas if the portion is a whole piece, it is preferably precooked/roasted. Publication WO9637111 discusses matters which are closely related to the present invention and thus the teachings obtainable from the publication are included in this patent application.

The invention and the method described in WO9637111 aim to solve the following drawbacks of the prior art.

The first drawback is what is called deep-freeze drying, which happens when liquid is evaporated from deep-frozen foodstuff.

The second drawback is related to the water layer to be frozen onto the surface of foodstuff. If the water layer to be frozen includes fat, the fat becomes slightly oxidized and causes defects in the flavor of foodstuff. Moreover, the fat or oil renders the surface of the foodstuff sticky, which impedes packing of the foodstuff, for example, packing it in a bag or in a corresponding product container.

Publication WO9637111 describes an embodiment in which sauce is applied as a component onto a portion so that the liquid exuding from the portion can be utilized in the formation of sauce. The portion tastes delicious because the proceeding is not completed until it is cooked in an oven or a micro-wave oven of a consumer. In the above-mentioned embodiment the portion is handled in a production unit as follows. At first vegetable oil or some other fat, which is congealed above 0° C. and may be spiced or unspiced, is applied onto the portion. A liquid layer including wheat flour, starch or some other precipitable substance, i.e. the substance to be thickened at the temperature of +70° C., as well as gelatine (isinglass) to inhibit the running of liquids between +0 and +30° C., is applied onto the above-mentioned layer. Moreover, a layer which inhibits oxidation and which may include water, is applied onto this second layer. In addition to the water, the layer inhibiting oxidation may include gelatine which thickens when above 0° C. and prevents the liquid from exuding from the portion at the range of +0° C. to +30° C. The processing of the sauce is not completed, i.e. in more detail the sauce is not thickened, until it is cooked in the oven or in the micro-wave oven of a consumer, when all liquid and flavor substances included in the portion and the sauce components can be utilized.

FIG. 1 shows a cross-section of layers which are applied onto a portion and which include the sauce components. The layers are in accordance with the embodiment of publication WO9637111 as described above. A portion 101 containing fish, for example, is placed on the bottom of the container 102. The innermost layer 103 located on top of the portion (and around it) includes vegetable oil or fat, and possibly spices. The middle layer 104 includes liquid, a thickening agent, and possibly gelatine. The outermost layer 105 is the layer that inhibits oxidation and may include thickening and possibly gelatine.

The third drawback of the prior art relates to the alternative in FIG. 1 in which a thickening agent and/or gelatine are added to the layer 105 inhibiting oxidation. In that case the thickening is prone to deep-freeze drying. When a consumer cooks the sauce in an oven or in a micro-wave oven, the sauce is badly thickened if some of the thickening agent is spoilt because of deep-freeze drying.

Also the fourth drawback of the prior art is related to FIG. 1. The drawback is that fat and spices are located in their own layer 103 and the thickening agent is located in a different layer 104. Then a portion of the sauce will be thickened without the fat and the spices, which decreases the quality of the sauce.

The fifth drawback of the prior art concerns the packaging of the sauce components. A dense container, i.e. a container having too low volume, causes the formation of clumps in the sauce when a portion is cooked in its container. Then the portion must be completely defrosted before the heating and thickening of the sauce can be started. Because the dense container thickening occur at the bottom of the container, a hard, lumpy layer is formed and the rest of the sauce remains unthickened.

### SUMMARY OF THE INVENTION

An objective of the invention is to solve the above-mentioned drawbacks. Sauce components can be covered with liquid is frozen. There are preferably two layers to be frozen. The inner layer includes at least a thickening agent and a precipitable substance, such as gelatine which thickens when cool. The inner layer includes the liquid needed for the maturation of the sauce. In addition, it may include fat (or oil), spices, and salt. The other, i.e. the outer layer, includes either only water or mainly water. It is important that the outer layer does not include a thickening agent, precipitable substance, or fat.

The components of the inner layer, especially the thickening and the precipitable substances are mixed together before they are frozen. In more detail, the components of the inner layer when chilled must reach the appropriate viscosity. The components are not applied onto the surface of a portion until the viscosity is appropriate. The components are applied onto the surface by pouring them over the portion or by dipping the portion into a liquid containing the components. The outer layer 105 is the oxidation-inhibition layer, which may include a thickening agent and gelatine. There may also be a number of portions, for example, broiler slices.

Another objective of the invention is to offer a pure sauce product for consumers. When the sauce product is placed in its own container and a portion is placed in another container, a consumer can freely combine different sauce products and portions.

Still another objective of the invention is to enable the manufacture of a pure sauce product, without portions. It is easier to ensure the quality when the manufacturer can concentrate on spicing and packing of the sauce product.

In the method in accordance with the invention the thickening and precipitable substances are mixed with the other sauce components, resulting in a mixture which reaches a predetermined viscosity. Then the mixture is frozen to at least −10° C. and is placed in a container which withstands deep-freezing and heating, and which in connection with the heating has a predetermined size of space at the bottom and/or inner sides of the container for the defrosting and thickening of the mixture.

The invention further includes a sauce product. The sauce product can be cooked in a closed container or container that withstands heating.

The invention further includes a container intended for foodstuffs that include the sauce product in accordance with the invention. The container is manufactured so that it withstands deep-freezing and heating and it offers in connection with free space for defrosting and thickening of the sauce product. This free space is situated between the non-melted foodstuffs and the inner surface of the container. The free space is large enough to keep the melted foodstuff inside the container. The container can be shaped in many different ways, and it can be made of various materials.

### BRIEF DESCRIPTION OF THE DRAWINGS

The invention is described more closely with reference to the accompanying drawings, in which

FIG. 1 shows in accordance with prior art a cross-section of layers which are applied onto a portion and include the sauce components,

FIG. 2A shows in accordance with the invention a cross-section of layers which are applied onto a portion,

FIG. 2B shows the thickening process of the sauce,

FIG. 3 shows a manufacturing method for sauce,

FIG. 4 shows an example of a sauce product,

FIG. 5A shows an example of a vacuum-packed sauce product,

FIG. 5B shows an example of the vacuum-packed sauce product when cooking of the sauce product has been started,

FIG. 6 shows the cooking of a sauce product in a clay pot.

FIG. 7A shows an example of a container equipped with a ledge,

FIG. 7B shows the same container from above,

FIG. 7C shows a ledge of the container,

FIG. 8A shows another example of a container equipped with a ledge,

FIG. 8B shows holes formed in the ledge,

FIG. 9A shows an example of a container equipped with projections,

FIG. 9B shows the same container from the side,

FIG. 9C shows one projection of the container,

FIG. 10A shows another type of a projection,

FIG. 10B shows another example of a container equipped with projections,

FIG. 11 shows still another example of projections,

FIG. 12A shows an example of a container equipped with one projection,

FIG. 12B shows the same container from the side.

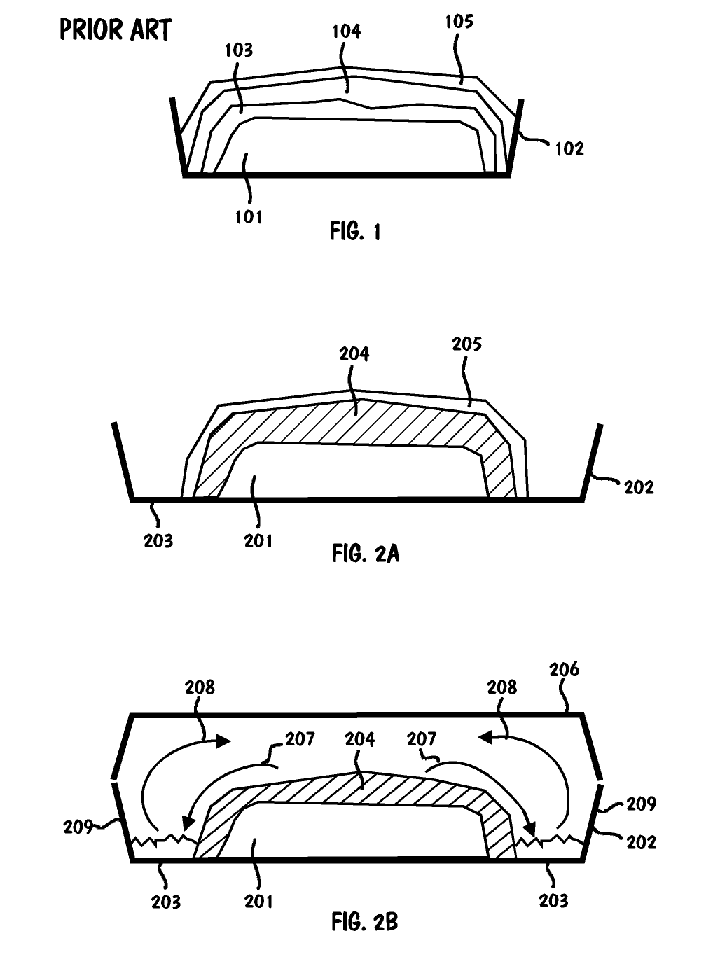

### DETAILED DESCRIPTION OF THE INVENTION

The thickening agent related to the method and the sauce product is wheat flour, maize meal, or any other thickening substance appropriate for thickening in temperatures higher than 70° C. The precipitable substance related to the method and the sauce product is gelatine (isinglass) or another appropriate substance for thickening at cool temperature.

FIG. 2A shows a cross-section of layers which are applied onto a portion in accordance with the invention and which are frozen using, for example, liquid nitrogen or a deep freezer. A portion 201 including for example fish, is placed on the bottom 203 of a container 202. The inner layer 204 located on top of the portion (and around it) includes at least thickening and precipitable substances. In addition, the inner layer 204 preferably includes at least one of the following sauce components: liquid, vegetable oil or some other fat, spices, and salt. Also the portion 201 may include fat, spices, and/or salt. The outer layer 205 is the layer which inhibits oxidation and which includes either only water or mainly water.

If needed, the oxidation inhibition layer 205 can be omitted. It can be replaced with a vacuum container that encases the sauce components of layer 204.

FIG. 2B shows the thickening process for the sauce. The heating of the portion 201 has started, and a lid 206 is placed on top of the container 202. In this phase the outer layer 205, which surrounded the portion, has defrosted and thus is not visible in FIG. 2B. The melted mixture, which has been separated from the inner layer 204, is running 207 along the edge of the portion 201 to the bottom 203 of the container 202. At the bottom of the container the melted mixture begins quickly to boil and thicken. Boiling results in hot steam 208 that defrosts the portion 201 further, as well as the layer 204 surrounding it and containing the sauce components. The container 202 is large enough for the thickening process, because there is sufficient free space between the bottom 203 of the container and lid the 206. The free space includes air and steam. Moreover, the container 202 is shaped in an appropriate way. First of all, the lid 206 makes the container 202 dense enough, i.e. an appropriate level of excess pressure inside the container expedites the thickening process. Secondly, there is free space for the thickening process. In more detail, the free space is situated between the portion 201 and the sides 209 of the container 202. Certainly, the free space is also situated between the portion 201 and the lid 206, but at there the free space does not expedite the thickening process as long as the portion 201 is frozen. When the layer 204 is at last totally defrosted and the melted mixture is thickened into the sauce, the portion 201 and the sauce are ready to be enjoyed.

The first detail which is important from the point of view of the invention is that the thickening agent and the precipitable substance are mixed with the other sauce components before the mixture composed of them is frozen. When the mixture melts during heating, the melted substance includes precisely the appropriate amount of thickening agent. The second important detail is that the container is dense enough and correctly shaped. When the above-mentioned details are taken into account, thickening of the sauce is realized as a continuous process as shown in FIG. 2B. In other words, the melting and thickening of the mixture occurs simultaneously happened so that the sauce is cooked in a relatively short time and the quality of the sauce is high.

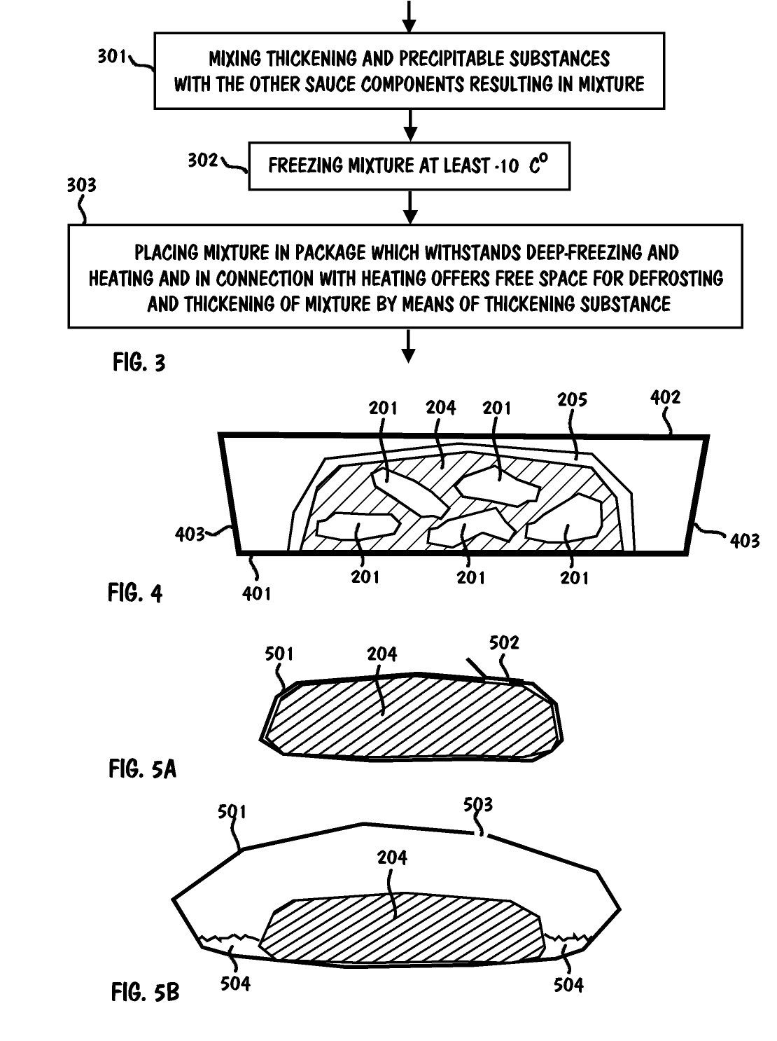

FIG. 3 shows the steps in the method for the manufacturing of the sauce components for thickening the sauce. The steps can be performed, for example, in a production unit in which ready-made foods are produced. First of all, the thickening and precipitable substances are mixed 301 with the other sauce components, resulting in a mixture that reaches by means of the precipitable substance a predetermined viscosity at the temperature range of +0° C. to +30° C. Then the mixture is frozen 302 to at least −10° C. and finally the mixture is placed 303 in a container which withstands deep-freezing and heating, and which in connection with the heating offers free space at the bottom of the container for defrosting and thickening of the mixture by means of the thickening substance, said free space being situated between the non-melted mixture and the inner surface of the container. The thickening of the mixture usually starts at the temperature of +70° C. The known thickening substances work best in temperatures higher than 70° C. The heating of the mixture is also required for purposes of food hygiene.

The free space is large enough to keep the melted mixture inside the edges of the container during the heating.

Generally speaking, the size of the free space is determined on the basis of the volume of the mixture, i.e. the larger the volume of the mixture the more space (at the bottom of the container) is needed for the thickening process shown in FIG. 2B.

At least one of the following components is included in the above-mentioned other sauce components: liquid, fat, oil, spices, or salt. Normally the mixture reaches the predetermined viscosity at the temperature range of +0° C. to +30° C.

The following steps are optional.

The method further comprises the step of freezing the mixture onto at least one portion before closing the container. This step is a sub-step of the step 302. It should be noticed that a portion may be a solid piece or it may be cut into pieces.

The method further comprises the step of covering the mixture with an ice layer inhibiting oxidation when the mixture is frozen. This step is another sub-step of the step 302.

The container in which the mixture is placed is one of the following: a flowpack type of container, a roasting bag, a sack type of container, a closed container composed of a lid and a bottom part.

In order to reduce the size of the container, the mixture can be vacuum packed. If the sauce is intended to be cooked in its container, the vacuum pack must be such that the free space expands in it in when it is being heated.

FIG. 4 shows an example of a sauce product and its manufacturing steps. The sauce product is composed of the inner layer 204 and the outer layer 205. The portions 201 are broiler slices which are mixed with layer 204. The mixing is performed when the inner layer 204 is in precipitated form. The inner layer and the portions are placed in molds whose temperature is lowered to under −10° C., whereby each mold renders an appropriate size and form for the sauce product and the portions. When the content of a mold is frozen, the outer layer 205 is formed, for example, by spraying water of +0° C. onto the frozen content so that the water freezes into ice. Finally the sauce product including the inner layer 204 and the outer layer 205, is placed at the bottom of a container 401, and a lid 402 is attached to the container 403. There is enough free space between the outer layer 204 and the bottom and/or sides 403 of container the 402 for thickening of the sauce. Instead of a casserole type of container 401, it is possible to use a container that withstands deep-freezing and heating.

Broiler slices are just one example of a portion. The portion may include meat, fish, and/or another foodstuffs.

FIG. 5A shows an example of a vacuum-packed sauce product. The sauce product is exclusively composed of the inner layer 204. The outer layer 205, which inhibits fat oxidation and deep-freeze drying of the sauce components, is omitted because a vacuum pack 501 performs the same task. When the sauce product is stored as a frozen food, the vacuum pack 501 tightly encloses the sauce product. The vacuum pack 501 includes a tape 502 covering the air intake hole inside the vacuum pack and thus preventing the passage of air.

FIG. 5B shows an example of a vacuum-packed sauce product after the cooking of the sauce product has begun. Before starting to cook the sauce product 204, the user has removed from the vacuum pack 501 the tape 502 covering the air intake hole 503. When the sauce product is heated, for example, in a micro-wave oven, the pleats of the vacuum pack 501 are uncurled and the vacuum pack expands into a sack. Expansion occurs because of the excess pressure created by heating inside a sack (i.e. inside the vacuum pack 501). As a result of high pressure excess air comes out of the sack though air intake hole 503. The material, which is loosened by defrosting of the sauce product 204, boils and gets thickened at the bottom 504 of the sack.

As shown in FIG. 5A, the sauce product can be placed in a sack type of container such as a vacuum pack. A sack type of container, which is suitable for deep-frosting and heating, is used in a second embodiment of the method.

The second embodiment of the method comprises the steps of a) mixing thickening and precipitable substances with the other sauce components resulting in a mixture that reaches by means of the precipitable substance a predetermined viscosity at the temperature range of +0° C. to +30° C., b) freezing the mixture to at least −10° C., c) placing the mixture in the container, d) removing air from the container through an air intake hole, and e) covering the air intake hole, wherein the container withstands deep-freezing and heating and which in connection with the heating expands and offers free space for defrosting and thickening of the mixture, said free space being situated between the non-melted mixture and the inner surface of the container. Thus, in the second embodiment of the method the container expands to a predetermined size of space during the heating and this space includes the free space for the thickening.

When a sauce product is in its own container and a portion in a different container, a consumer can freely combine different sauce products and portions.

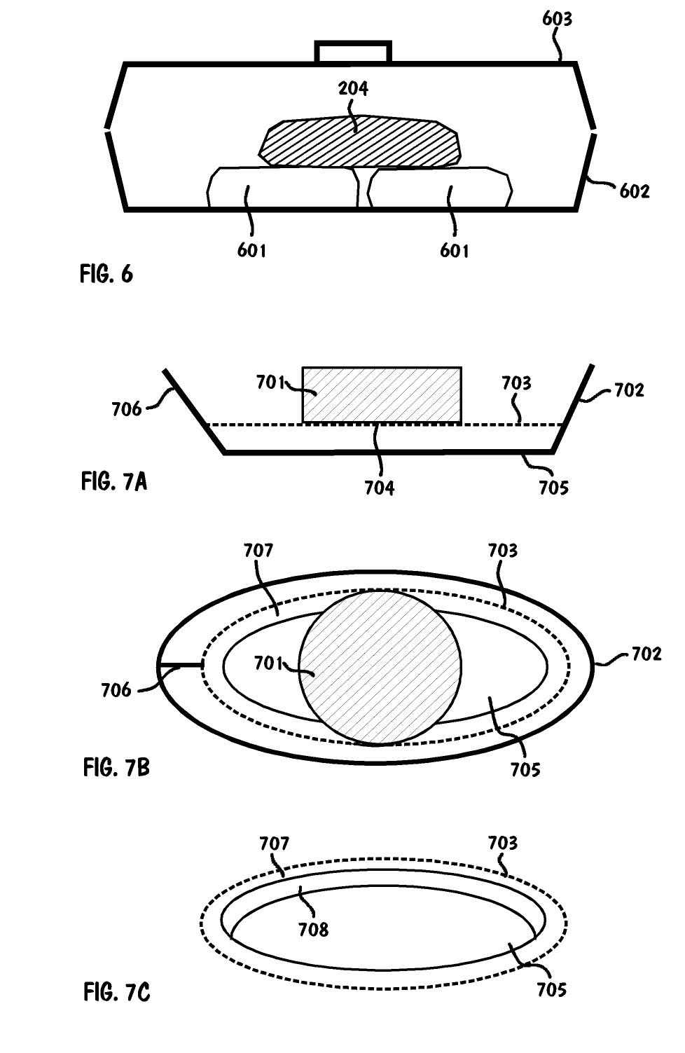

FIG. 6 shows the cooking of a sauce product in a clay pot. Let us assume that a consumer has bought raw hamburger steaks 601 and cooked them for a time in an oven. After this the consumer took the frozen sauce product 204 from its container and placed the frozen sauce product 204 into the clay pot 602 on top of the hamburger steaks 601. Then the consumer sets the lid 603 of the clay pot in place and put the clay pot back into the hot oven or a short time. Thus the sauce gets ready together with the steaks.

The sauce product in accordance with invention is as follows. The thickening and precipitable substances included in the sauce product are mixed with the other sauce components until the mixture reaches a predetermined viscosity, after which the mixture is frozen to at least −10° C. Characteristics of the mixture are such that in connection with heating, the frozen mixture defrosts and gets thickened in the free space at the bottom of the closed container. At least one of the following components is included in the other above-mentioned sauce components: liquid, fat, oil, spices, or salt.

The closed container may be a container in which the sauce product is packed and which withstands deep-freezing and heating.

The closed container may also be a different container as the container in which the sauce product is packed. A clay pot, a serving dish, or some other container dense enough to withstand heating is suitable as the cooking container.

In addition to the manufacturing method for sauces and the sauce product, the invention comprises a container for the sauce product. This container is manufactured so that it withstands deep-freezing and heating, and in connection with the heating it provides free space for defrosting and thickening the sauce product. This free space is situated between the non-melted foodstuffs and the inner surface of the container.

The container in accordance with the invention substantially maintains its shape, thus it is not a roasting bag or a sack. The container can be made of cardboard, plastic, polypropene, polyethelene terephthalate (PET), aluminium, or some other material, or a combination of the above-mentioned materials. The container shown in FIG. 2B is one example of the container in accordance with the invention.

In the following other examples of the container are introduced.

FIG. 7A shows an example of a container equipped with a ledge. The container is observed from the side. The deep-frozen foodstuff 701, including the sauce product, is placed in the container 702. The container 702 is equipped with a ledge 703 (dashed line) that keeps the bottom 704 of the deep-frozen foodstuff 701 apart from the bottom 705 of the container 702. Then there is free space for the thickening of the sauce at the bottom 705 of the container 702. The container 702 also includes a notch 706 for pouring the ready-made sauce out of the container 702.

FIG. 7B shows the same container from above. There is the notch 706 for pouring the sauce. The deep-frozen foodstuffs 701 lie on the upper surface 707 of the ledge 703. The deep-frozen foodstuff 701 is circular when it is observed from above. The container 702 is oval, which makes it easier to pour the ready-made sauce out of the container. In other words, a portion of the sauce may stick to corners of the container. Therefore an oval-shaped container or a container with rounded corners is ideal when pouring out the sauce. The free space for the thickening of the sauce is situated on left side and right side of the deep-frozen foodstuff 701 and under the deep-frozen foodstuff 701. As can be seen in the figure, the shape of the deep-frozen foodstuff 701 is such that it does not divide the free space intended for the thickening into separated areas. The thickening process proceeds in a better way when the container allows the sauce to gather and thicken in one area only.

FIG. 7C shows the ledge 703 of the container 702. The ledge 703 comprises an upper surface 707 on which the deep-frozen foodstuff lies and a side surface 708. The side surface 708 of the ledge 703 extends to the bottom 705 of the container 702. The ledge 703 is preferably made of the same material as the container 702. The container 702 is preferably shaped so that it includes the ledge 703.

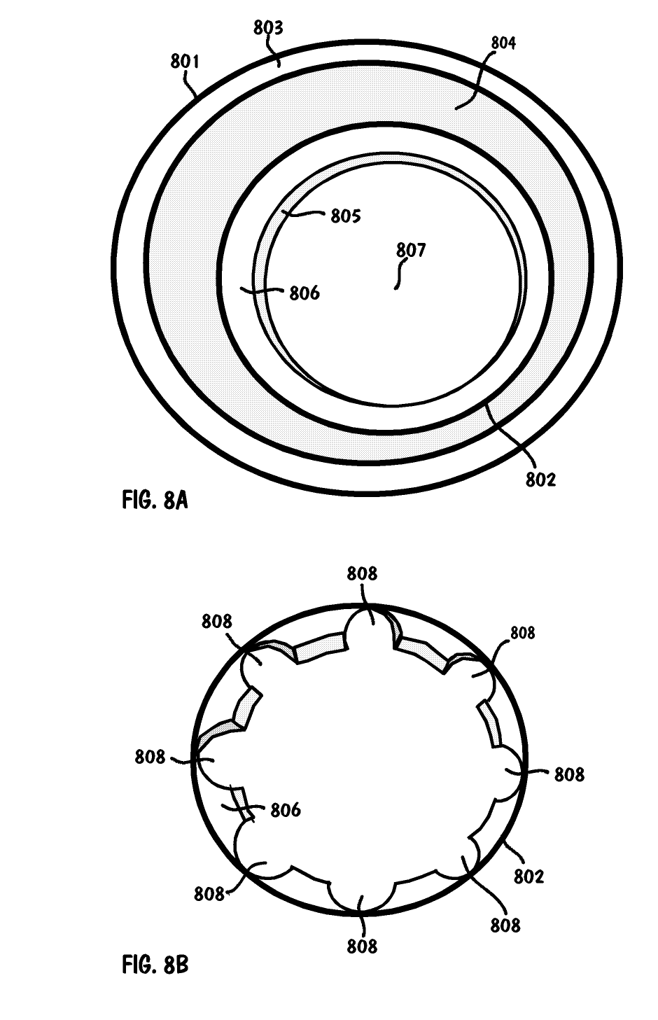

FIG. 8A shows another example of a container equipped with a ledge. The shape of the container 801 is round and also the ledge 802 formed in the container 801 is round. The container 801 includes an extended edge 803 that makes the container stronger. The inner side 804 of the container and the side surface 805 of the ledge 802 are marked with a gray color. The edge 803, the upper surface 806 of the ledge 802, and the bottom 807 of the container are white. It is possible to place round-shaped deep-frozen foodstuff on the upper surface 806 of the ledge 802, but this round-shaped deep-frozen foodstuff may divide the container in two parts so that the melted mixture loosened from the deep-frozen foodstuff is located on the upper surface 806 of the ledge 802 and on the bottom 807 of the container. Thus, there are two separated spaces for the thickening process. This can be avoided when the shape of container differs essentially from the shape of the deep-frozen foodstuff. Let us assume that the shape of the deep-frozen foodstuff is square. Then the deep-frozen foodstuff does not block the melted mixture on the upper surface 806 of the round ledge 802. In other words, the melted mixture drips freely from the upper surface 806 of the ledge to the bottom 807 of the container.

FIG. 8B shows holes formed in the ledge. The holes 808 are an alternative way to keep the free space intended for the thickening process as undivided space, which is situated at the bottom 807 of the container 801. The melted mixture loosened from deep-frozen foodstuff drips freely from the upper surface 806 of the ledge 802 through the holes 808 to the bottom 807 of the container 801.

The ledge is one way, but not the only way, to shape the container so that it includes free space for defrosting and thickening the sauce. Instead of a ledge it is possible to use one or more projections situated on the inside of the container. The container is preferably shaped so that it includes the projections.

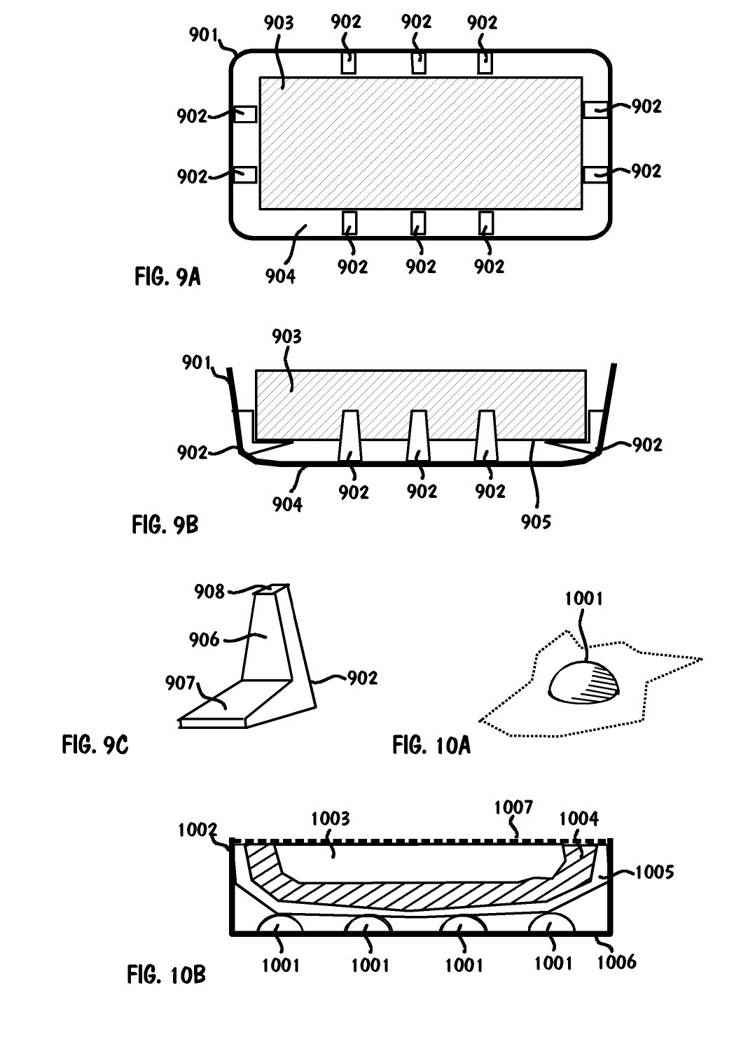

FIG. 9A shows an example of a container equipped with projections. The container 901 is observed from above. The container 901 is rectangular, i.e. it has two long sides and two short sides. The container 901 includes ten projections which are marked with 902. The top edges of the projections 902 can be seen in the figure.

FIG. 9B shows the same container from the side. Let us assume that one of the long sides of the container 901 is removed. As can be seen in the figure, the projections 902 keep the underside 905 of deep-frozen foodstuff 903 apart from the bottom 904 of the container 901.

FIG. 9C shows one projection of the container. The projection 902 is composed of a vertical part 906 and a horizontal part 907. The top edge of the projection 902 is numbered 908. The vertical part 906 keeps the sides of deep-frozen foodstuff 903 apart from the sides of the container 901. Correspondingly, the horizontal part of the projection 902 keeps the underside 905 of the deep-frozen foodstuff 903 apart from the bottom 904 of the container.

The projection shown in FIG. 9C has the drawback that it makes it difficult to pour the ready-made sauce out of the container. When pouring out the sauce, a portion of it may stay “under” the projection/projections 902.

FIG. 10A shows another type of projection. The shape of the projection 1001 is rounded. Then the sauce does not stay on the projection or “under” the projection when the sauce is being poured out.

FIG. 10B shows another example of a container equipped with projections. The container is observed from the side. The container 1002 includes the projections 1001, which keep the deep-frozen foodstuff apart from the bottom of the container. The deep-frozen foodstuff is composed of the portion 1003, the sauce product 1004 in accordance with the invention, and the water layer 1005 preventing deep-freeze drying of the components of the sauce product 1004. There is air in the lower part of the container 1002. This space between the bottom 1006 of the container 1002 and the water layer 1005 is the free space is needed during the thickening of the sauce. Because the deep-frozen foodstuff extends from one side of the container to the opposite side of the container, the free space extends over the entire bottom of the container. The dashed line 1007 illustrates that the deep-frozen foodstuff can be covered with another water layer. Alternatively, the deep-frozen foodstuff can be covered with a lid or foil. Also the lid/foil prevents or decelerates deep-freeze drying.

When comparing the deep-frozen foodstuff shown in FIG. 10B to the portion shown in FIG. 2A, we can think that the portion 201 with the sauce component layer 204 and the water layer 205 is turned upside down and placed in the container 1002.

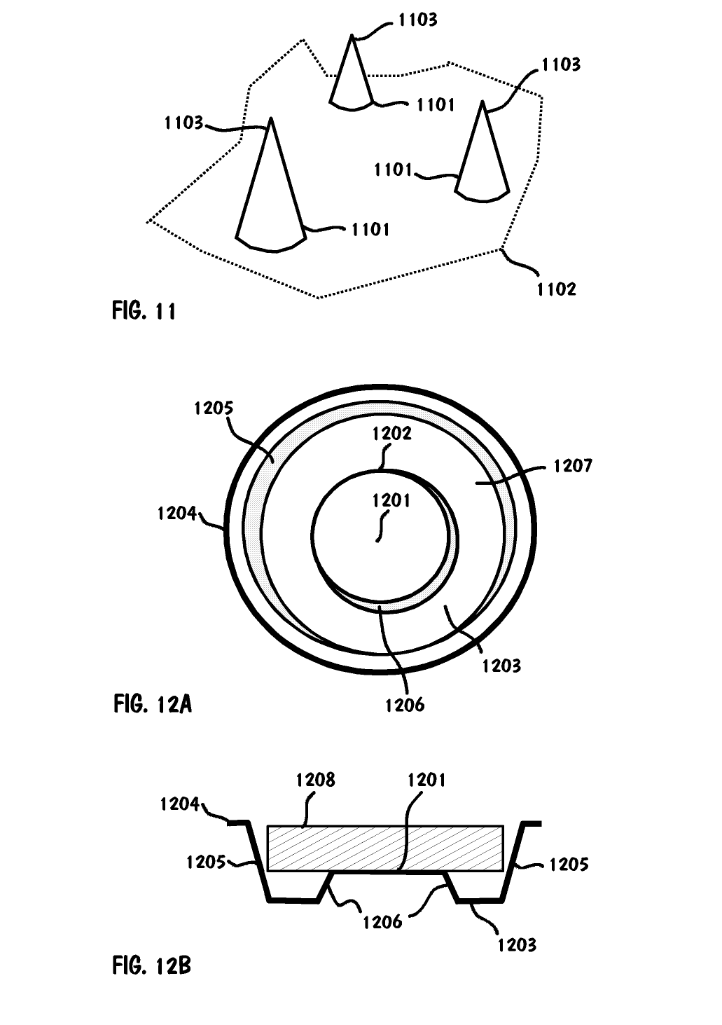

FIG. 11 shows still another example of projections. Each projection 1101 is the shape of a cone. The figure shows the piece 1102 of the bottom of a container and the three projections 1101 each of them having a prong 1103.

If deep-frozen foodstuff is laid down on the projections 1101, only the prongs 1103 of projections touch the deep-frozen foodstuff. Thus, three projections can hold deep-frozen foodstuff so that the deep-frozen does not touch the bottom of a container. However, two projections or even one projection can do the same thing.

FIG. 12A shows an example of a container equipped with a single projection. The upper surface 1201 of the projection 1202 is so large that deep-frozen foodstuff can lie on it. In other words, the projection 1202 prevents the deep-frozen foodstuff from touching the bottom 1203 of the container 1204. The inner side 1205 of the container 1204 and the side surface 1206 of the projection 1202 are marked with a gray color. The free space 1207 for the thickening is ring-shaped.

FIG. 12B shows the same container from the side. The figure also shows the deep-frozen foodstuff 1208 laid down on the upper surface 1201 of the projection 1202.

In the following the container in accordance with the invention is specified by means of the above examples.

A container (702, 801, 901, 1002, 1204) is intended for a sauce product in which thickening and precipitable substances are mixed with other sauce components, resulting in a mixture that reaches a predetermined viscosity, after which the mixture is frozen to at least −10° C., the mixture having characteristics such that in connection with heating the frozen mixture defrosts and thickens. The container (702, 801, 901, 1002, 1204) is made of material which withstands deep-freezing and heating. In addition, the container (702, 801, 901, 1002, 1204) is shaped so that it offers in connection with the heating a predetermined size of free space for the defrosting and the thickening of the mixture placed in the container, the free space being situated between the non-melted portion of the mixture and the inner surface of the container. The above-mentioned mixture is included in the foodstuff (701, 903, 1208). In addition to the mixture, the foodstuff (701, 903, 1208) may include one portion or several food pieces. The layer 1004 is one example of the above-mentioned mixture.

The implementation of the container is related to the following options.

The free space is at least partly situated at the bottom (705, 807, 904, 1006, 1203) of the container (702, 801, 901, 1002, 1204).

The free space is at least partly situated long the inside of sides of the container (702, 901).

The free space is undivided space (702, 801, 901, 1002, 1207).

The shape of the container (702, 801, 901, 1002, 1204) is such that it at least partly prevents the frozen mixture/foodstuff from touching the inner sides of the container and/or the bottom (705, 801, 904, 1006, 1203) of the container.

The shape of the container (702, 801, 901, 1002, 1204) is such that it at least partly prevents the frozen mixture/foodstuff from touching the bottom (705, 801, 904, 1006, 1203) of the container.

The container (702, 801) includes a ledge (703, 802) separating the mixture from the bottom (705, 807) of the container when the mixture is frozen.

The ledge (802) formed in the container (801) includes holes (808).

The bottom of the container (702, 801, 901, 1002, 1204) is similar to one of the following shapes: an oval, a circle, a rectangle, or a square.

The inner surface of the container (702, 801, 901, 1204) is rounded in order to support the thickening of the mixture.

The container (702) includes a notch (706) for pouring out the sauce of the mixture.

The container (901, 1002, 1204) includes at least one projection (902, 1001, 1201) separating the mixture from at least one side of the container and/or the bottom (904, 1006, 1203) of the container when the mixture is frozen.

The container (702, 801, 901, 1002, 1204) is made of at least one of the following materials: cardboard, plastic, polypropene, polyethelene terephthalate (PET) or aluminium.

A person skilled in the art can create by means of his/her professional ability and the above ideas various alternatives for the sauce manufacturing method, the sauce product, and the container for the sauce product. However, these alternatives can be considered to be included in the scope of the invention as defined in the accompanying claims.

1-11. (canceled)

12. A container for a sauce product in which thickening agent and precipitable substance are mixed with other sauce components, resulting in a mixture whose viscosity is set by means of the precipitable substance at the temperature range of +0° C. to +30° C., after which the mixture is frozen to at least −10° C., the mixture having characteristics such that during heating the frozen mixture defrosts and at least at the temperature +70° C. thickens by means of the thickening agent, the container being made of material which withstands deep-freezing and heating,
characterized in that the container is shaped so that it providers in connection with the heating a predetermined size of free space for the defrosting and the thickening of the mixture placed in the container, the free space being situated between the currently non-melted portion of the mixture and the inner surface of the container.

13. The container as in claim 12, characterized in that the free space is at least partly situated at the bottom of the container whereat hot steam resulted from the heating flows under the frozen mixture and defrosts the frozen mixture from below.

14. The container as in claim 12, characterized in that the free space is at least partly situated along the inside of sides of the container.

15. The container as in claim 12, characterized in that the free space is undivided space.

16. The container as in claim 12, characterized in that the shape of the container is such that it at least partly prevents the frozen mixture from touching the inner sides of the container.

17. The container as in claim 12, characterized in that the shape of the container is such that it at least partly prevents the frozen mixture from touching the bottom of the container.

18. The container as in claim 12, characterized in that the bottom of the container is similar to one of the following shapes: an oval, a circle, a rectangle, or a square.

19. The container as in claim 12, characterized in that the inner surface of the container is rounded.

20. The container as in claim 12, characterized in that the container includes a ledge separating the mixture from the bottom of the container when the mixture is frozen.

21. The container as in claim 20, characterized in that the ledge includes holes

22. The container as in claim 12, characterized in that the container includes a notch for pouring out the thickened sauce product.

23. The container as in claim 12, characterized in that the container includes projections separating the mixture from at least one side of the container and/or the bottom of the container when the mixture is frozen.

24. The container as in claim 12, characterized in that the container is made of at least one of the following materials: cardboard, plastic, polypropene, polyethelene terephthalate (PET), or aluminium.

25. A method for manufacturing sauce from sauce components, the method comprising the steps of:
mixing thickening agent and precipitable substance with at least one additional sauce components, resulting in a mixture having a viscosity controlled by said precipitable substance at a temperature range between 0° C. and 30° C.;
freezing said mixture to at least −10° C.;
placing said mixture in a container capable of withstanding deep freezing and heating;
said container having free space sufficient to support at least the volume of mixture after defrosting and thickening;
wherein said thickening of the mixture occurs at or above +70° C.

26. A method as claimed in claim 25, wherein said free space is situated between said frozen mixture and an inner surface of said container.

27. A method as claimed in claim 25, wherein said additional sauce component is selected from a group consisting of liquid, fat, oil, spice, salt, an any combination thereof.

28. A method as claimed in claim 25 wherein said step of freezing said mixture is performed by freezing said mixture onto a food portion.

29. A method as claimed in claim 25, further comprising the step of covering the mixture with an ice layer for inhibiting oxidation when the mixture is frozen.

30. A method as claimed in claim 25, wherein said container is of a container type selected from a group consisting of a flowpack, a roasting bag, a sack, and a multi-part container having at least a bottom portion and a lid portion.

31. A method as claimed in claim 25 wherein said container is a vacuum pack having sufficient volume to expand and contain the defrosted mixture and said free space when the vacuum pack is heated.

32. A sauce preparation product comprising
a thickening agent, precipitable substance, and at least one additional sauce component;
said precipitable substance controlling the viscosity of a sauce at a temperature range of between 0° C. and 30° C. when said sauce is cooked from said sauce preparation product
wherein after mixing said thickening agent, said precipitable substance, and said additional sauce component, and freezing the resultant mixture at a temperature at or below 10° C., said thickening agent begins to thicken said sauce after being heated to a temperature of 70° C. in a container, said container having free space sufficient to support thickening of said sauce preparation product when cocked into said sauce.

33. A sauce product as claimed in claim 32, wherein said freezing and said heating occur in said container capable of withstanding a deep freezing process.

34. A sauce product as claimed in claim 32, wherein said sauce product is packed in a different container as said container in which said heating occur.
